(19) United States
(12) Patent Application Publication
(10) Pub. No.: US 2023/0274293 A1
(43) Pub. Date: Aug. 31, 2023

(54) Method and system for conducting online retailing taking into account client characteristics

(71) Applicant: Andrey A. Tunikov, Zaporozhskoye,Leningrad Region (RU)

(72) Inventor: Andrey A. Tunikov, Zaporozhskoye (RU)

(21) Appl. No.: 17/768,596

(22) PCT Filed: Oct. 14, 2019
(86) PCT No.: PCT/RU2019/000730

§ 371 Date: Apr. 13, 2022

(51) Int. Cl. G06Q 30/0201; G06Q 30/0208

(52) U.S. Cl. CPC G06Q 30/0201; G06Q 30/0208

(57) ABSTRACT

Method and system for conducting online retailing taking into account buyer's individual characteristics, the method comprising placing an offer of a seller's product over the system indicating open data on the product and regular price thereof; saving hidden data in the system, including the minimum acceptable product price (MAPP), buyer's individual characteristic requirements, and hidden scenarios of testing a buyer to identify individual characteristics thereof; sending a counteroffer by the buyer with the buyer's price; sending a test offer to the buyer according to the test scenario selected by the system; testing the buyer, upon buyer's consent, to identify the degree of compliance of the buyer's individual characteristics with the requirements; converting the identified compliance degree into a monetary equivalent to add same to the buyer's price; and comparing the resulting amount with the MAPP to implement a product sale transaction if the amount is not less than the MAPP.

### TECHNICAL FIELD

The invention relates generally to methods and systems that provide mutually beneficial interactive online communication between a commercial entity and its potential client, during which the client demonstrates his individual characteristics to the commercial entity, and the commercial entity in return provides the client with a reward, calculated taking into account the compliance of the client's individual characteristics with the requirements of the commercial entity.

In particular, the present invention relates to a method and system for identifying the degree of compliance of the client's individual characteristics with the requirements of a commercial entity; a method for providing a reward by a commercial entity to a client taking into account his individual characteristics; a computer system for calculating a reward to a client taking into account his individual characteristics; and a method and system for conducting online retailing via a networked computer system.

### BACKGROUND OF THE INVENTION

As is known, making a transaction in a market economy implies negotiations between the seller and the buyer to agree on the terms of this transaction. In addition to the solely commercial aspect, according to which during the negotiations the parties manage to set a compromise (ideally fair) price for the goods, negotiations also have a human, emotional aspect that should not be underestimated. Thus, owing to the interaction that occurs during negotiations between the seller and the buyer, a sense of partnership arises and, depending on the assessment by each of the counterparties of the personal qualities of the other party, a long-term loyalty to the transaction partner is formed. Obviously, this loyalty can be monetized to some extent. For example, in case of sympathy for a certain buyer, the seller can give him a big discount that is impossible for other clients of this seller.

Unfortunately, in the modern world, the principles of conducting retailing between the seller and the buyer are undergoing significant changes. For example, the development of chain retailing, the distinctive feature of which is the presence of one common center that determines the pricing policy for all branches of the chain, resulted to the fact that the buyer's prospects to affect the pricing of goods are virtually reduced to zero. In this case, the buyer's real opportunities to get a discount on the goods he is interested in are limited only by the discounts offered by the seller, which are general unified discounts for all users, as a rule, seasonal, promotional or cumulative. As a result, when buying goods in a retail chain store, the buyer's individual characteristics do not matter at all, and there is no possibility of negotiating to reduce the cost of the goods in principle. The buyer is offered only two alternatives: either to buy the goods at the proposed price, or to refuse to buy the goods. Unfortunately, this situation infringes the interests of the buyer, putting him at a known disadvantage in relation to the seller.

With the development of digital technologies and the Internet, the aforesaid mismatch between the opportunities of the seller and the buyer increases even more due to the development of methods that allow tracking the buyers' preferences by their digital trace on the Internet. Such methods, inter alia, make it possible to accurately assess the solvency of a single buyer, which means that they give the seller the opportunity to set the price for the goods only based upon the buyer's solvency, not accounting for the other parameters, such as the buyer's emotional state and his individual characteristics.

Considering the current level of chain retailing and online commerce, it becomes obvious that in the modern world there are no price formation mechanisms alternative to those determined directly by commercial entities and, in particular, mechanisms that take into account the intangible psychological characteristics of the buyer, in addition to his solvency. However, the feeling of underestimation of personality of the buyer and an exclusively material interest guiding the seller's actions causes the buyer's dissatisfaction, which can subsequently develop into a conflict between the parties of a transaction.

It is well known that for the buyer the importance of a product consists not only of the product's functionality, quality and price, but also depends on the belonging of the purchased product to a particular brand. The buyer's personal attitude to the brand known to him often determines the buyer's long-term commitment (loyalty) to the corresponding manufacturer/seller. It is obvious, that with a high degree of loyalty of the buyer to the seller, the latter, without losing its competitive advantages in the market, can reduce the cost of advertising and non-targeted discount campaigns in relation to unpromising buyers. In this case, to increase the efficiency of business, the seller can focus only on personal promotions for the benefit of loyal buyers.

Currently, there are only two models of trading known from the prior art: seller-driven trading and buyer-driven trading. In fact, the vast majority of systems for processing the sale of goods are seller-driven, wherein the seller prices, packages, configures and offers the product for sale, and the buyer decides whether or not to accept the seller's offer. In a buyer-driven system, the buyer dictates the terms of the offer, and one or more sellers decide whether or not to accept the offer. However, regardless of the specific model, the methods of transaction management, known from the prior art, either do not provide the buyer with a discount on the goods at all, or offer the buyer a certain fixed discount, the amount of which is determined by the seller regardless of the buyer's actions and characteristics and which is final and not discussed for the buyer.

The closest analogue of the present invention in terms of the set of essential features is the technical solution disclosed in U.S. Pat. No. 6,332,129, wherein a method and system for processing the sale of goods are proposed. The main object of U.S. Pat. No. 6,332,129 is a method comprising the steps of: obtaining a first conditional purchase offer for the product from a buyer, containing at least a description of the product, a price and a payment identifier for specifying a manner in which funds may be paid; providing a questionnaire having a first question and a first and a second answer to the buyer; receiving one of the first and second answer from the buyer; providing the first conditional purchase offer to a plurality of potential sellers; determining whether one or more of the sellers have accepted the first conditional purchase offer, and if one or more sellers have not accepted the first conditional purchase offer: performing a predetermined action based upon the received answer, and subsequent generating for the sellers a second conditional purchase offer, including at least the said product, based on the said predetermined action.

The disadvantages of the described closest analogue include, first of all, the inability of the buyer to negotiate with the seller by presenting reasons and arguments aimed at reducing the price of the goods. In U.S. Pat. No. 6,332,129, opportunities to bargain are limited solely to the sequential change in the buyer's price offer. In addition, in accordance with U.S. Pat. No. 6,332,129, the buyer has no guarantees that in return to the price proposed by him, the goods will be provided by the company that is close to him for any reason, for example, causes his greatest respect, because if the buyer's price offer is acceptable, the order will be transferred to that participant-seller of the system who has formed the most advantageous offer for the trading platform. Another disadvantage of the solution proposed in U.S. Pat. No. 6,332,129 is that the questionnaire used therein has limited possibilities for assessing the buyer's individual characteristics, since all the buyer's answers are reduced to a choice from the answers prepared in advance. This means that the buyer's answers are evaluated in the system not to identify the buyer's individual characteristics, but rather to specify his commercial goals. Thus, it should be obvious that the analogue according to U.S. Pat. No. 6,332,129 does not provide the buyer with the opportunity to affect the price of goods, including by demonstrating his individual characteristics and emotional state to the seller.

Accordingly, in the field of conducting online retailing, there is a need for such methods and systems that would overcome the disadvantages of the prior art and, in particular, would allow the parties involved in retailing to come to a compromise price of the goods during interactive communication with each other. In addition, in the prior art, there is a need for such methods and systems that would allow a commercial entity to increase its popularity with a potential client by psychological rapprochement with this client during a virtual dialogue, as well as by providing the client with a reward corresponding to his individual characteristics, revealed as a result of this dialogue. In addition, in the prior art, there is a need for methods and systems that allow a commercial entity to identify such potential clients that would be close to it by their individual characteristics, for example, by moral and ethical qualities. Finally, in the prior art, there is a need to develop such methods and systems that could make conducting online retailing via the Internet less machine-like and impersonal, but, on the contrary, more human and gambling, bringing it closer to the traditional (face-to-face) trading, typical, for example, for a city bazaar.

### SUMMARY OF THE INVENTION

The task of the claimed group of inventions is to overcome at least one disadvantage of the prior art and to satisfy at least one of the needs listed above. This task is achieved by developing the following subject matters of the invention: a method and system for identifying the degree of compliance of client's individual characteristics with the requirements of a commercial entity; a method for providing a reward by a commercial entity to a client, taking into account his individual characteristics; a computer system for calculating a reward to the client, taking into account his individual characteristics; and a method and system for conducting online retailing via a networked computer system, taking into account the individual characteristics of the buyer.

The technical result of the claimed invention is to provide mutually beneficial interaction between a commercial entity and its client, during which the commercial entity identifies the client's individual characteristics, converts them into a reward for the client according to their ideas about the value of the identified characteristics of the client and provides the client with the said reward. Proposed by the claimed invention is a mechanism for monetizing the client's individual characteristics, which the client can advantageously use to reduce the price of goods.

According to the first aspect of the invention, proposed is a method for conducting online retailing via a networked computer system comprising the steps of: placement by the seller of an offer to sell a product with indication of open data on this product, containing at least its name and regular price; saving, by the seller, hidden data on the product, including its minimum acceptable price, which is equal to or less than the regular price of the product to the system; saving, by the seller, hidden data on his requirements for the buyer's individual characteristics to the system; saving at least one hidden scenario of testing the buyer to identify his individual characteristics to the system; selecting a product by the buyer and sending an offer to the seller to purchase the product at the price proposed by the buyer; the system select scenarios of testing the buyer; the system sends an offer to the buyer to take a test according to the selected test scenario; if the buyer accepts, the buyer is tested and test results are obtained by the system, identifying the degree of compliance of the buyer's individual characteristics with the seller's hidden requirements; the system converts the obtained test results into a monetary equivalent and sums this monetary equivalent with the price proposed by the buyer; the system compares the sum calculated in the previous step with the minimum acceptable price of the product; the system implements a transaction for the sale of the product at the price proposed by the buyer, if the sum calculated is not less than the minimum acceptable price of the product.

According to one embodiment of the invention, the system performs the step of converting the obtained test results into a monetary equivalent by assigning an appropriate weighting coefficient to each test result, followed by summing these coefficients, while the weighting coefficient assigned to each test result can be randomly selected by the system.

According to another embodiment of the invention, the method further comprises the steps of: saving hidden data with the requirements for the buyer's individual characteristics to be identified during testing to the system; the system identifies the buyer's individual characteristics from the obtained test results; calculating for each individual characteristic of the buyer, identified during testing, the degree of its compliance with the specified requirements from hidden data; the system performs the said step of converting the obtained test results into a monetary equivalent taking into account the specified calculated degrees characterizing the compliance of the identified characteristics of the buyer with the requirements from hidden data; for testing the buyer, a scenario is selected aimed at identifying specific individual characteristics of the buyer prescribed in the specified requirements from hidden data.

According to one embodiment of the invention, in the step of saving at least one hidden test scenario, more than one scenario of testing the buyer is saved. In this case, the test scenarios used may differ from each other by at least one of the following parameters: complexity, volume, duration of implementation, focus on identifying specific individual characteristics.

According to one embodiment of the invention, the steps of saving hidden data with the requirements for the buyer's individual characteristics and saving at least one scenario of testing the buyer to the system are performed by the seller. However, in an alternative embodiment, these steps are performed by a third party.

According to one embodiment of the invention, the specified requirements for the buyer's individual characteristics include requirements for his emotional state.

According to one embodiment of the invention, testing is carried out by questioning a buyer during a system-driven dialogue with the buyer.

According to one embodiment of the invention, the buyer is tested by entering text data into the system.

According to one embodiment of the invention, the system selects a scenario of testing the buyer based on the price proposed by the buyer. However, in an alternative embodiment, the system randomly selects a scenario of testing the buyer.

According to one embodiment of the invention, the method further comprises a step, wherein the system invites the buyer to retest for individual characteristics and/or raise the proposed price if the specified calculated amount is less than the minimum acceptable price of the goods. The system can select a scenario for retesting that differs from the previous one by increased complexity and/or volume and/or duration of implementation, while in ordinary case, the system refuses to sell the goods to the buyer at the price proposed by the buyer if the buyer refuses to continue testing or raise the proposed price.

In the preferred embodiment of the claimed method, the Internet is used as a network.

According to one embodiment of the invention, the hidden data, used in the proposed method, with the requirements for the buyer's individual characteristics is generated in such a manner that an appropriate weighting coefficient is assigned to each individual characteristic, and the weighting coefficient is selected taking into account the importance of this individual characteristic, while the system performs the step of converting the obtained test results into a monetary equivalent taking into account the weighting coefficients corresponding to those individual characteristics of the buyer that were identified by the system in the step of testing the buyer.

According to one embodiment of the invention, in the step of sending an offer to the seller to purchase goods, the buyer indicates the details of his bank card, while the system performs the step of implementing a transaction for sale of the goods by debiting from the buyer's bank card the amount corresponding to the price proposed by the buyer.

According to a preferred embodiment of the invention, the seller places online the specified offer for the sale of goods.

According to one embodiment of the invention, the method comprises a further step, wherein the system sends a message to the buyer about providing the buyer with a discount on the purchase of goods in the amount of the specified monetary equivalent.

The first aspect of the invention also relates to a computer system for conducting online retailing, including: a memory tool that stores: open data on a product, containing at least the name and regular price of the product; hidden data on a product, containing its minimum acceptable price being equal to or less than the regular price of the product; and at least one hidden scenario of testing a buyer to identify his individual characteristics; a processor device; means of communication of the processor device with the memory tool and with the network; wherein the processor device is configured to perform the following actions: publishing online an offer to sell a product with indication of open data on this product; receiving an offer from the buyer to purchase the product at a price proposed by the buyer; selecting a scenario of testing the buyer for his individual characteristics from the scenarios available in the memory tool; sending an offer to the buyer to take a test to identify his individual characteristics according to the selected test scenario; if the buyer accepts, the buyer is tested and test results that correspond to the buyer's individual characteristics are obtained; converting the obtained test results into a monetary equivalent and summing this monetary equivalent with the price proposed by the buyer, comparing the calculated amount with the minimum acceptable price of the product; implementing a transaction for the sale of the product at the price proposed by the buyer, if the sum calculated is not less than the minimum acceptable price of the product.

According to the second aspect of the invention, proposed is a method for providing a reward by a commercial entity to a client taking into account his individual characteristics, implemented via a networked computer system and comprising the steps of: saving at least one hidden scenario of testing a client to identify his individual characteristics to the system; the system sends an offer to the client to take a test to identify his individual characteristics according to the selected test scenario in exchange for a possible reward; if the client accepts, the client is tested and test results that correspond to the client's individual characteristics are obtained by the system; the system converts the obtained test results into a reward; providing the client with a reward.

According to one embodiment of the invention, the system performs the step of converting the obtained test results into a reward by assigning an appropriate weighting coefficient to each test result with the subsequent summation of these coefficients, while the weighting coefficient assigned to each test result can be randomly selected by the system.

According to another embodiment of the invention, the method further comprises the steps of: saving hidden data with the requirements for the client's individual characteristics to be identified during testing to the system; the system identifies the client's individual characteristics from the obtained test results; calculating for each individual characteristic of the client, identified during testing, the degree of its compliance with the specified requirements from hidden data; the system performs the said step of converting the obtained test results into a reward taking into account the specified calculated degrees characterizing the compliance of the identified characteristics of the client with the requirements from hidden data; for testing the client, a scenario is selected aimed at identifying the client's specific individual characteristics prescribed in the specified requirements from hidden data.

According to one embodiment of the invention, the said reward is material, in particular, monetary.

According to one embodiment of the invention, the step of providing a reward to a client is performed by a commercial entity. However, in an alternative embodiment, the step of providing a reward to a client is performed by the said system, authorized by a commercial entity.

According to one embodiment of the invention, the steps of saving hidden data with the requirements for the client's individual characteristics and saving at least one scenario of testing the client to the system are performed by a commercial entity. However, in an alternative embodiment, these steps are performed by a third party.

According to one embodiment of the invention, the specified requirements for the client's individual characteristics include requirements for his emotional state.

According to one embodiment of the invention, testing is carried out by questioning a client during a system-driven dialogue with the client.

According to one embodiment of the invention, the client is tested by entering text data into the system.

In the preferred embodiment of the claimed method, the Internet is used as a network.

In the preferred embodiment, the system performs the step of sending an offer to the client to take a test in response to the client's request for the services of a commercial entity.

According to one embodiment of the invention, hidden data, used in the proposed method, with the requirements for the client's individual characteristics is generated in such a manner that an appropriate weighting coefficient is assigned to each individual characteristic, and the weighting coefficient is selected taking into account the importance of this individual characteristic, while the system performs the step of converting the obtained test results into a monetary equivalent taking into account the weighting coefficients corresponding to those individual characteristics of the client that were identified by the system in the step of testing the client.

In the preferred embodiment of the claimed method, a commercial entity is the seller of goods, a client is the buyer of the goods, and a reward to the client is a monetary bonus added to the price proposed by the buyer.

The second aspect of the invention also relates to a computer system for calculating a reward to a client taking into account his individual characteristics, including: a memory tool that stores: at least one hidden scenario of testing a client to identify his individual characteristics; a processor device; means of communication of the processor device with the memory tool and with the network; wherein the processor device is configured to perform the following actions: selecting a scenario of testing the client for his individual characteristics from the scenarios available in the memory tool; sending an offer to the client to take a test to identify his individual characteristics according to the selected test scenario; if the client accepts, the client is tested and test results that correspond to the client's individual characteristics are obtained; converting the obtained test results into a reward.

According to the third aspect of the invention, proposed is a method for identifying the degree of compliance of the client's individual characteristics with the requirements of a commercial entity, implemented via a networked computer system and comprising the steps of: saving hidden data with the requirements for the client's individual characteristics and at least one scenario of testing the client to identify his individual characteristics to the system; the system sends an offer to the client to take a test to identify his individual characteristics according to the selected test scenario; if the client accepts, the client is tested and test results that correspond to the client's individual characteristics are obtained by the system; the system calculates the degree of compliance of the client's individual characteristics, identified during testing, with the specified requirements from hidden data; saving the calculated degree of compliance to the database.

According to one embodiment of the invention, the steps of saving hidden data with the requirements for the client's individual characteristics as well as saving at least one scenario of testing the client to the system are performed by a commercial entity. However, in an alternative embodiment, these steps are performed by a third party.

According to one embodiment of the invention, the specified requirements for the client's individual characteristics include requirements for his emotional state.

According to one embodiment of the invention, testing is carried out by questioning a client during a system-driven dialogue with the client.

According to one embodiment of the invention, the client is tested by entering text data into the system.

In the preferred embodiment of the claimed method, the Internet is used as a network. According to one embodiment of the invention, the system performs the step of sending an offer to the client to take a test in response to the client's request for the services of a commercial entity.

According to one embodiment of the invention, the method further comprises a step of saving to the database the client's test results, corresponding to his individual characteristics. At the same time, in the preferred embodiment, the method also comprises a step of sending the client's test results and/or the calculated degree of compliance from the database to a commercial entity. In an alternative embodiment, the method comprises a step of sending the client's test results to a third party unrelated to the said commercial entity, carried out in response to a corresponding request from the third party and with the consent of the commercial entity.

The third aspect of the invention also relates to a computer system for identifying the degree of compliance of client's individual characteristics with the requirements of a commercial entity, including: a memory tool that stores: hidden data with the requirements for the client's individual characteristics; and at least one hidden scenario of testing a client to identify his individual characteristics; a processor device; means of communication of the processor device with the memory tool and with the network; wherein the processor device is configured to perform the following actions: selecting a scenario of testing the client for his individual characteristics from the scenarios available in the memory tool; sending an offer to the client to take a test to identify his individual characteristics according to the selected test scenario; if the client accepts, the client is tested and test results that correspond to the client's individual characteristics are obtained by the system; calculating the degree of compliance of the client's individual characteristics, identified during testing, with the specified requirements from hidden data; saving the calculated degree of compliance to the database.

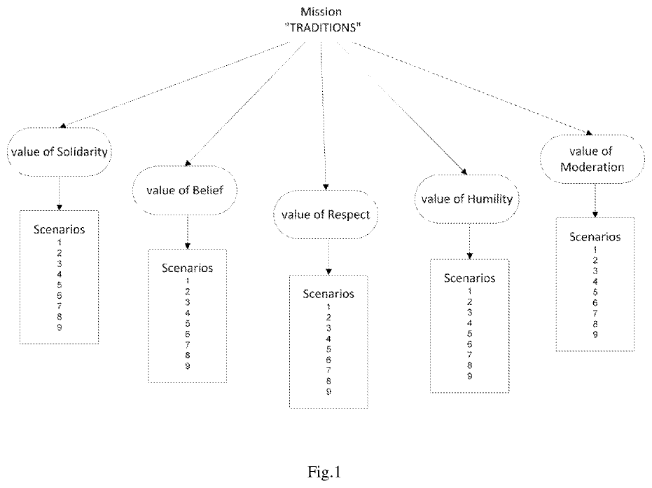

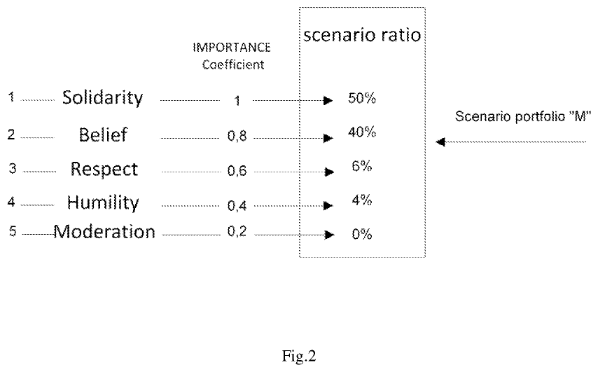

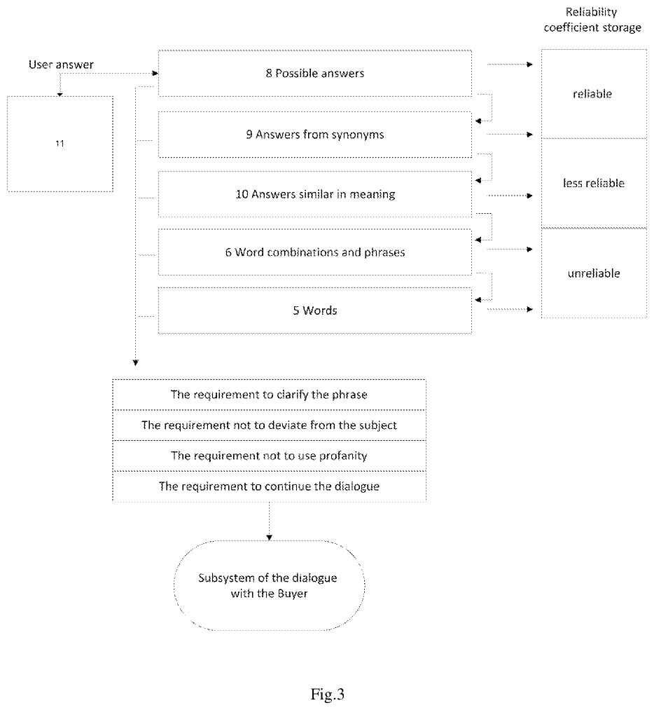

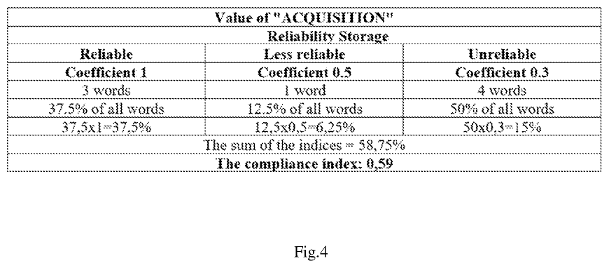

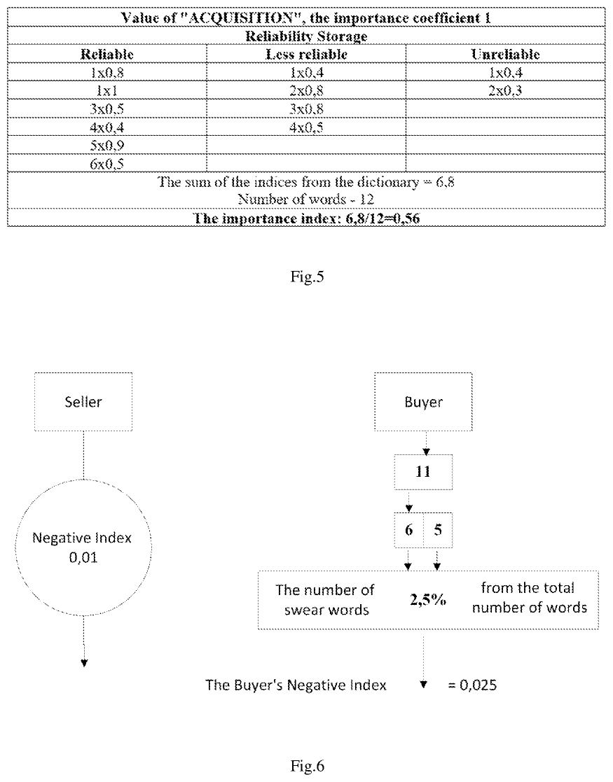

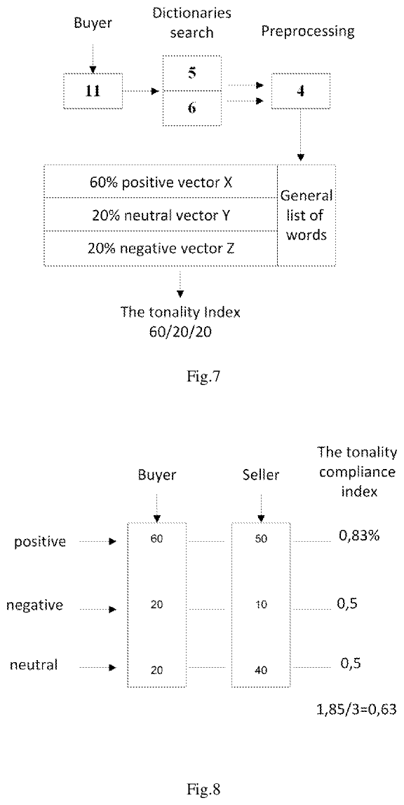

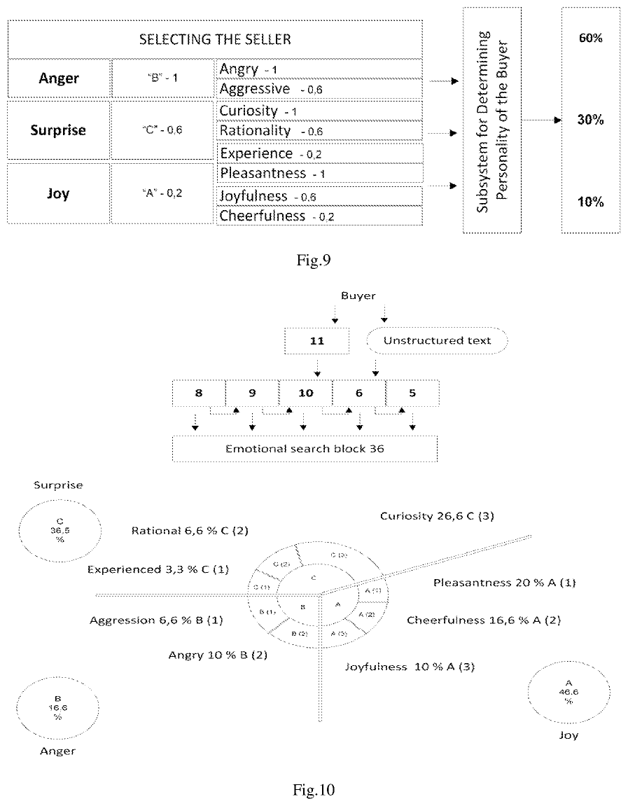

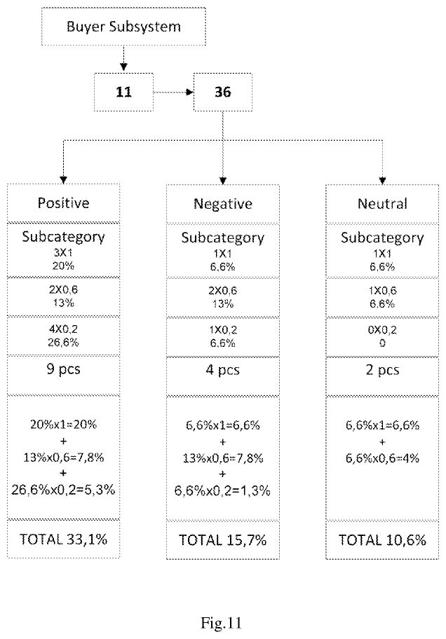

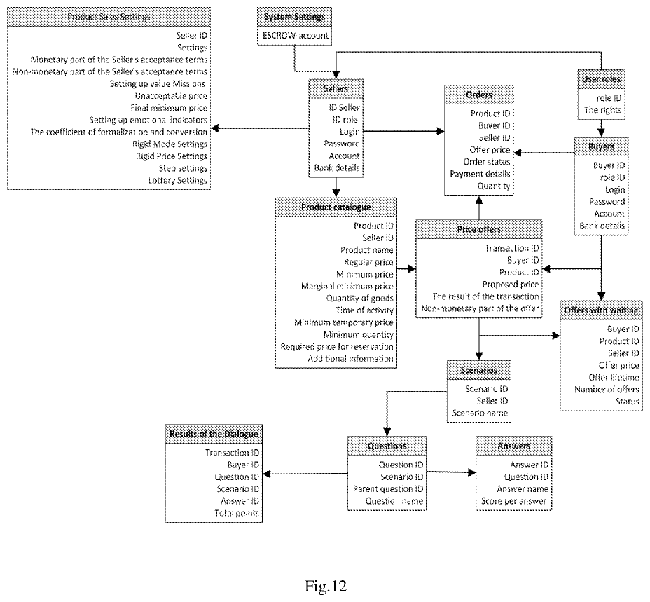

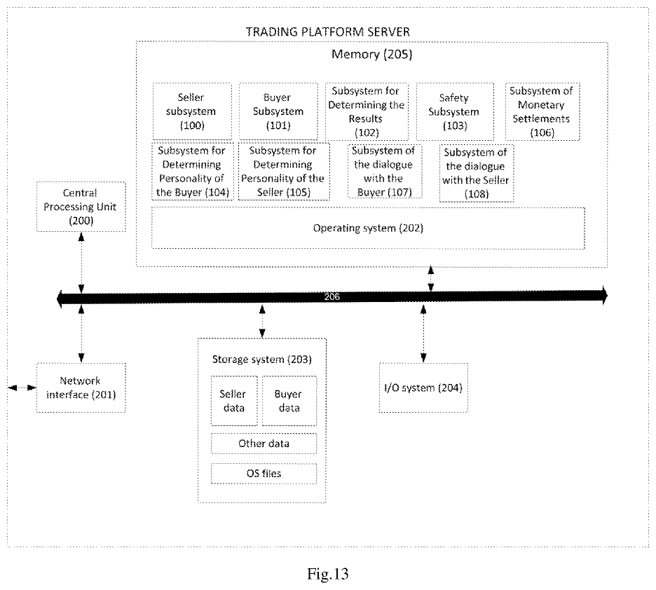

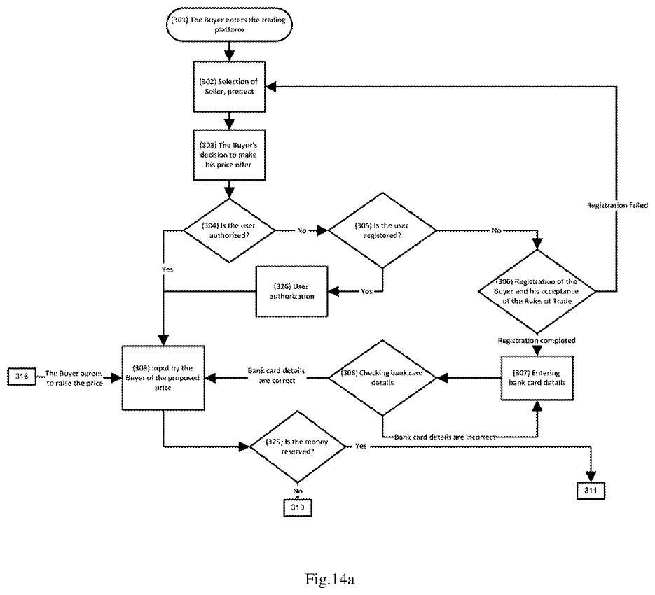

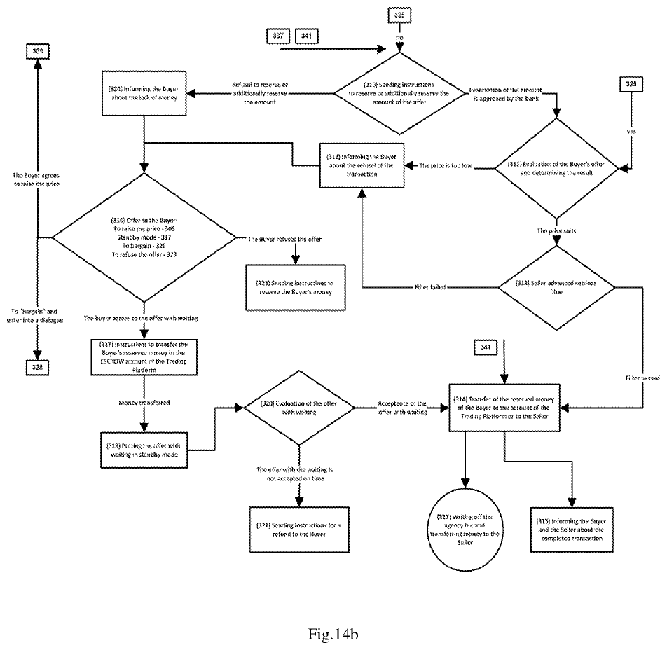

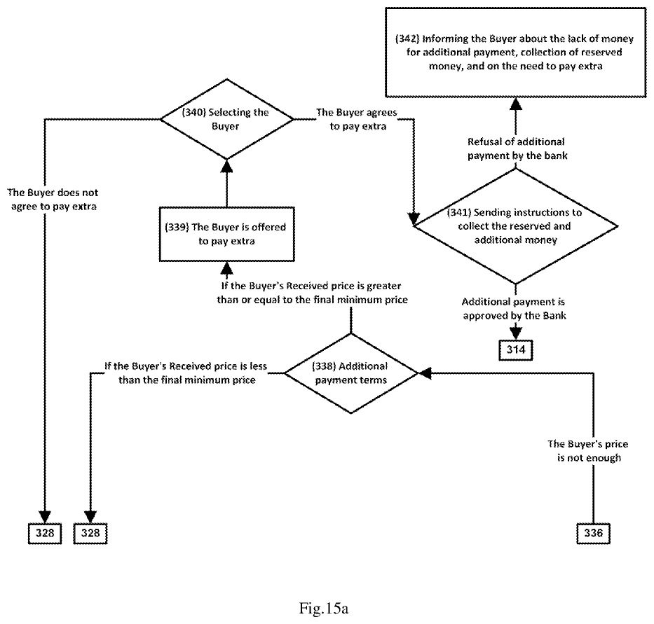

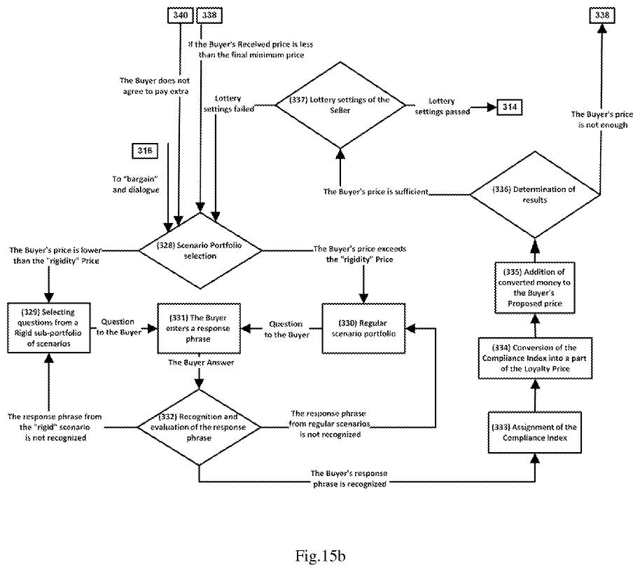

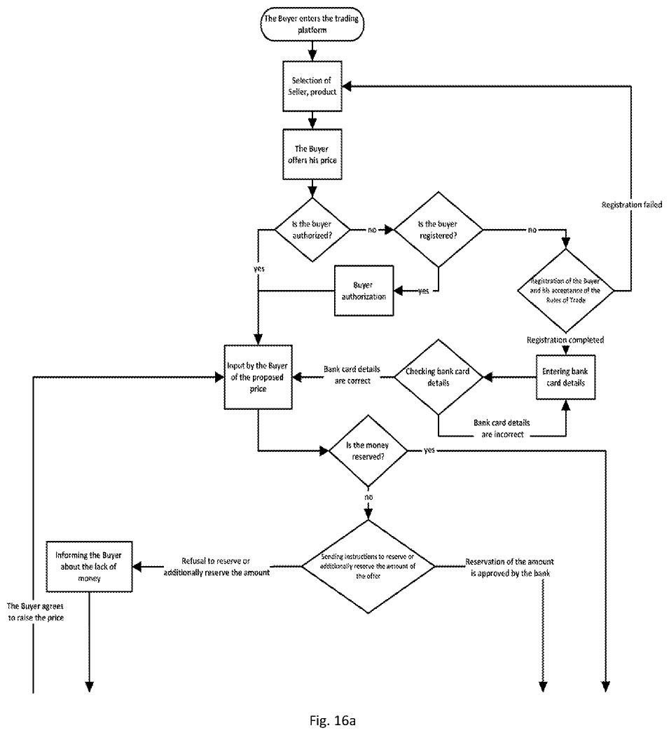

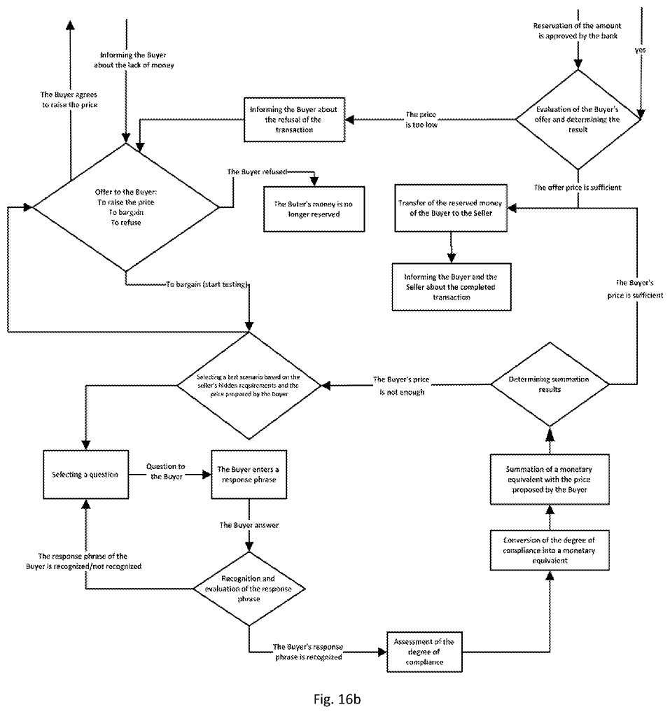

The sequence of instructions in the system for conducting online retailing taking into account buyer's individual characteristics is shown in the FIGS. 16a and 16b.

### DETAILED DESCRIPTION OF A GROUP OF INVENTIONS

Before disclosure of the embodiments of the invention, let us consider a number of general issues for better understanding the text below.

Despite the fact that the methods and systems included in the proposed group of inventions can act as independent autonomous objects, and each is designed to implement its own task indicated in its name, these objects are interrelated according to “one is a part of the other” principle, therefore they should be recognized as meeting the requirement of unity of invention. For example, a method for identifying the degree of compliance of client's characteristics with the requirements of a commercial entity may be a part of a method for providing a reward by a commercial entity to a client, whereas the latter mentioned method may be a part of the method for conducting online retailing. The same relates to the claimed systems. For example, a system for identifying the degree of compliance of client's individual characteristics with the requirements of a commercial entity can be used not only to implement its direct purpose, indicated in its name, but also applied as a part of a system for calculating a reward for a client or as a part of a system for conducing online retailing.

It is also worth noting that the proposed group of inventions can be implemented only via a computer network, namely, a network, interconnecting users' computer devices with the possibility of transferring information between them. This statement does not mean that all actions, without exception, performed according to the invention must be implemented using a network and computers. As will be shown below, some of the actions, for example, placement by the seller of an offer to sell a product or sending by the buyer an offer to purchase a product can be performed in a traditional (not computer-assisted) manner, for example, as in an ordinary retail store. However, actions related to testing the buyer to identify his individual characteristics and to calculating a reward for the buyer based on the identified characteristics are to be performed only via a computer system.

The type of computer network is not essential for the purposes of the present invention. To successfully implement the invention, any network, characterized by any set of parameters such as architecture, topology, type of transmission medium, data transfer rate, functionality, and so on, can be used. Nonetheless, it should be understood that, in view of the state of the art, the most preferred network for implementation of the present invention is the Internet.

Equally, the devices included in the computer network according to the present invention can also be of a wide diversity of varieties, for example, desktop computers, laptops, smartphones, tablets, mobile phones, and the like.

In this application, a commercial entity is understood to mean any legal entity or individual (or a group of individuals) whose activities are aimed at interacting with others and involve receiving from others and/or providing them with certain tangible or intangible values. As specific examples of a commercial entity according to the present invention can be the following: a manufacturing company, a financial institution, a fund, a household, etc. However, the most common type of commercial entity and the most interesting for the purposes of the present invention is a trading company engaged in the sale of goods and/or services.

In view of the information from the previous paragraph, a counterparty of a commercial entity should be understood as its client. Obviously, if a commercial entity is a trading company, the client of this commercial entity will be a buyer who purchases or intends to purchase goods from the assortment of this trading company.

The term “goods” is used in this application in its widest possible meaning. This term must be understood as any product intended for sale or exchange. The goods can be products of physical and mental labor, tangible and intangible assets, both created and not created by man. As a non-limiting list of possible types of goods, we will name food, industrial products, art objects, movable and immovable property, services, information, minerals, etc.

The term “regular price of goods” within the scope of this application means the base price of goods at which the seller is initially intends to sell goods to any single buyer in the existing market conditions. The regular price corresponds to the usual (not adjusted by discounts) price of the goods and includes, as a rule, the cost of the goods and the expected profit that satisfies the seller. In contrast to the regular price, “the minimum acceptable price of the goods” means the price of the goods, below which the seller will not sell the goods due to the financial disadvantage of this transaction. In other words, the sale of goods at the regular price provides the seller with the profit the seller originally expected; the sale of goods at the minimum acceptable price provides the seller with the minimum acceptable profit; and the sale of goods at a price below the minimum acceptable price is not beneficial to the seller and he does not agree to such a transaction. Nonetheless, it is worth noting that, under special conditions, the seller may agree to sell the goods at a price below the minimum acceptable price. As a rule, this happens when the seller assumes that the immediate losses associated with the financial disadvantage of this transaction will be more than compensated in the future due to the beneficial effects of a non-financial nature achieved through this transaction. For example, a company may sell a product for some time without a profit, or even at a loss, in order to win the competition and attract new clients. The case of the sale of goods at a price below the minimum acceptable price, is considered below in the present description, when disclosing an exemplary embodiment of the invention.

The main concept of the invention, according to its preferred embodiment, is to provide mutually beneficial interaction between a commercial entity (for example, a seller of goods) and its client (for example, a buyer of goods), during which the commercial entity identifies the client's individual characteristics; converts them into a reward for the client according to their ideas about the value of the identified characteristics of the client; and provides the client with the said reward, for example, in the form of a discount on the goods being sold. In other words, the present invention provides a mechanism for monetizing the client's individual characteristics, which the client can advantageously use to reduce the price of goods (in particular, when negotiating with the seller).

The advantages of this solution for the client are quite obvious. In addition to financial advantage, according to which the client either receives a reward or saves money when buying goods, this solution also has a beneficial effect on the client's emotional state. The client is happy that communication with a commercial entity on a business matter was informal by its nature; he is glad that his individual characteristics were appreciated; and he is very pleased that he received a reward or negotiated a discount.

The advantages for the second party, being a commercial entity, are less obvious, but no less significant. Firstly, the commercial entity still implements the task of interacting with the client on acceptable terms. For example, in case of a trade transaction, the seller sells the goods to the buyer at a price acceptable for the buyer. Secondly, by testing clients for individual characteristics, the commercial entity receives information about the personal profiles of clients, which can be successfully used for marketing and other purposes. Thirdly, (and this is perhaps the most important), during testing and negotiations, the commercial entity receives commitment, loyalty, and to some extent, trustiness of the client. Actually, answering the target questions of a commercial entity, the client, willing or not, remembers the commercial entity, begins to be attached to it, to distinguish it from others. In addition, according to the laws of psychology the fact that the client received a reward in exchange for recognition his individual characteristics will be taken very positively by the client. Therefore, after that, the client will have positive feelings towards the commercial entity and, possibly, will become its regular counterparty.

Further, the proposed group of inventions is disclosed in a greater detail by the example of specific embodiments thereof.

From the most commercially advantageous point of view, the invention relates to a method for conducting online retailing via a networked computer system. This method is characterized by comprising at least the steps of (for convenience, these steps are designated by letters a-i, which, however, should not be considered as limiting the scope of the invention claims):
a) placement by the seller of an offer to sell a product with indication of open data on this product, containing at least its name and regular price;
b) saving, by the seller, hidden data on the product, including its minimum acceptable price, which is equal to or less than the regular price of the product to the system;
c) saving at least one hidden scenario of testing the buyer to identify his individual characteristics to the system;
d) selecting a product by the buyer and sending an offer to the seller to purchase the product at the price proposed by the buyer;
e) the system sends an offer to the buyer to take a test according to the selected test scenario;
f) if the buyer accepts, the buyer is tested and test results that correspond to the buyer's individual characteristics are obtained by the system;
g) the system converts the obtained test results into a monetary equivalent and sums this monetary equivalent with the price proposed by the buyer;
h) the system compares the amount calculated in the previous step with the minimum acceptable price of the product;
i) the system implements a transaction for the sale of the product at the price proposed by the buyer, if the calculated amount is not less than the minimum acceptable price of the product.

Let us consider each of the steps a)-i) in a sufficient detail for understanding the invention.

In step a) the seller forms and discloses to the public an offer to sell the goods. This disclosure can be implemented in various ways, including non-computer methods, for example, through mass media or by direct demonstration of the goods on the seller's site. However, in the most preferable case, which meets the current needs of society, the seller places an offer to sell the goods in an open web, in particular, on the Internet. Meanwhile, in the same step a), the seller indicates to an unlimited number of potential buyers open data on the proposed product, including the name of the product by which users can definitely identify this product, and its regular price. In the extended variant, the specified data may include other information about the product, for example, its description, list of characteristics, item number, date of manufacture, delivery terms, etc.

In step b), the seller saves hidden data on the minimum acceptable price of a product in the system. This data actually constitutes the seller's trade secret. Since this data is hidden from network users, users, and in particular, potential buyers of goods, are not able to know the lowest possible price of this product, and therefore, they cannot know how much the price of the product can be reduced in case of the most successful trade. In some embodiments of the invention, the said hidden data may further include information about the cost of the product, which does not necessarily have to coincide with the minimum acceptable price of the product and which, along with the minimum acceptable price, can be accounted for by the system when deciding whether the transaction is possible.

Step c) consists in saving to the system one or more hidden test scenarios, aimed at identifying by the system any individual characteristics of the buyer, for example, those of his features that, for some reason, are important for the seller of the goods. In the standard case, step c) is performed directly by the seller of the goods, who may have a clear idea of the individual characteristics that he would like to see in his potential trading partner. However, step c) can alternatively be performed by a third party, for example not related to the seller, but acting with the seller's knowledge. For example, instead of a seller, a specialized computer system, configured on the basis of a neural network and implementing a context-dependent algorithm of communication with a user to identify his psychographic profile, can test a buyer in step c). Such systems are quite widely represented in the prior art and are used, in particular, in search engines such as Google and Yandex, as software robots that analyze the behavior of Internet users. The services Sentiment Analysis, WordNet-Affect, Python Natural Language Toolkit, IBM WATSON Tone Analyzer and IBM Watson Personality Insights can be mentioned as specific examples of such systems.

In accordance with the invention, testing can take a variety of forms. For example, it can be in the form of a questionnaire or interviewing a buyer, or it can be in the form of a request to write a text or solve a test problem (in particular, a charade), evaluate a picture, express an opinion on a particular issue, etc. However, the most preferred testing option is interactive communication with the buyer in the form of a system-driven dialogue. The buyer can also respond in different ways, for example, by entering text, graphic or audio data into the system.

By analogy with the aforesaid with respect to the testing methods, test scenarios can also be focused on identifying a wide variety of individual characteristics of a person, for example, his personal, value, intellectual or psychological characteristics. Any feature of the buyer, for example, a tendency to use abusive language, literacy of speech, the frequency he refers to his relatives, the use of emoticons when writing, and the like can act as the buyer's individual characteristic to be identified. In some cases, it may be preferable to test the buyer to determine his emotional state.

In addition, referring to step c), it is worth noting that not one, but a greater number of test scenarios can be saved to the system, at least some of which may differ from each other by complexity, volume, duration of implementation, focus on identifying specific individual characteristics, etc.

Applicable to the steps a) to c) above, it should be obvious that steps b) and c) do not necessarily have to be performed after step a). For the claimed method, the sequence of steps a)-c) is not essential and can be any.

Having found information about the product of interest on the Internet, or having received it from any other sources, the buyer can send the seller an appropriate purchase offer (FIG. 16a). This happens in step d) of the claimed method, and in the preferred embodiment of the invention the buyer sends such an offer via the network. Alternatively, the buyer can make an offer to purchase the product in person, by regular mail, telephone or otherwise off-line, but such options, although they do not contradict the essence of the proposed invention, are less convenient and fail to meet the demands of time.

It is worth noting that if the buyer is satisfied with the regular price of the goods proposed by the seller and agrees to purchase the goods at this price, the further part of the proposed method substantially coincides with a traditional way of conducting online retailing. For example, in the most common case, the buyer enters his bank card details into a special form on the seller's website; the seller, through his bank, requests permission to authorize the purchase using the card specified by the buyer; the buyer's bank gives permission to debit funds from the buyer's card, and the transaction is completed.

However, the novelty of the method proposed in the present invention resides in the fact that it allows conducting negotiations between the seller and the buyer when implementing a transaction. Accordingly, at step d), the buyer, within his offer to purchase the goods, can assign to the seller the price at which he is ready to buy the goods (in the present application, this price is called the price proposed by the buyer). Obviously, the buyer is interested in purchasing the product at a lower price, therefore the price proposed by the buyer will be less than the regular price of the product. Namely this standard relationship between the regular price and the price proposed by the buyer will be considered below. However, for completeness of disclosure, it is worth noting that if the buyer offers a price that exceeds the regular price of the goods, the seller accepts such an offer from the buyer, and then the transaction will be processed in a usual manner. It is also worth noting that sending by the buyer to the seller of an offer to purchase goods at the price proposed by the buyer may equally be referred to in this application as sending the buyer's purchase offer to the seller.

Having received an offer from the buyer to purchase the goods at the price set by the buyer, the system at step e) sends a message to the buyer with an offer to take a test to identify his individual characteristics (FIG. 16b). As briefly mentioned above, this action is performed by the system in order to convert the buyer's individual characteristics into some kind of reward, for example, a monetary equivalent, which will be further accounted for by the system when deciding whether or not to sell the goods to the buyer at the price proposed by the buyer. In the materials of this application, the reward may also be called a bonus, discount and/or non-monetary part of the buyer's offer.

Before or during step e), the system can perform the procedure of selecting a test scenario for a particular buyer. The system can make this selection randomly or, alternatively, accounting for the price proposed by the buyer. The second alternative is preferred: for example, the greater the difference between the price proposed by the buyer and the regular price of the product, the more difficult and/or time-consuming testing the seller selects for the buyer.

In step f), the buyer accepts the offer sent by the system to take a test and is tested. It is worth noting that the situation when the buyer refuses to be tested is beyond the scope of this invention, since in this case the described method ends before proceeding to those steps that determine its novelty and advantages over known technical solutions (FIG. 16b). The buyer is tested by entering text, audio or graphic data into the system via a device connected to the network (for example, a smartphone). Testing is considered completed if the buyer answers at least part of the questions recognized by the system as sufficient. Accordingly, during step e), the system receives at least one set of test results containing an indication of the buyer's individual characteristics. The system can further analyze these results in order to determine on their basis the buyer's individual characteristics. Computer systems configured on the basis of a neural network perform this task quite simply and without serious errors. Meanwhile, it is worth noting that the present invention also allows an embodiment of the method, wherein the system operates with the obtained test results, without identifying the buyer's individual characteristics therefrom. As disclosed below referring to step g), this may happen when the system and/or the seller does not care about the buyer's individual characteristics and calculates a reward for the buyer without considering these characteristics.

In the vast majority of cases, the user's answers more or less exactly comply with the applied test scenario and the standard expectations of the analyzing system, and, therefore, the client's individual characteristics are selected from these answers in an ordinary manner. However, a situation is possible when the user on purpose answers the questions incorrectly and/or pointlessly, for example, trying to troll the system. In accordance with the proposed invention, such user behavior is completely acceptable, since in this case it can be analyzed to determine individual characteristics. The difference is that in this case the system will reveal a slightly different set of the client's individual characteristics than expected, for example, such characteristics as mischief, nonconformity, lack of intelligence, insanity, inadequacy, etc.

Upon completion of step f), the method proceeds to step g), which begins with converting by the system the buyer's test results, containing indications of his individual characteristics, into a monetary equivalent (FIG. 16b). The monetary equivalent received in step g) is a kind of reward that will be accounted for by the system when calculating the final cost of the goods for this specific buyer and which this buyer was able to earn by demonstrating his individual characteristics to the system. From the buyer's point of view, the said reward can be understood as a discount on the goods provided by the seller. However, in general, it is truly to say that the said monetary equivalent acts as a kind of monetized assessment of the buyer's individual characteristics and/or his emotional state.

In accordance with the preferred embodiment of the invention, the conversion of the obtained test results into a monetary equivalent is performed by assigning an appropriate weighting coefficient to each identified individual characteristic of the buyer, followed by summing these coefficients. In this case, according to one of the possible embodiments, the system can select these weighting coefficients randomly, which means that the value of the calculated monetary equivalent will turn out to be independent of the user's answers. This embodiment of the invention may have sense when it is not important for the seller that the calculated monetary equivalent corresponds to the real characteristics of the buyer, and, as a result, that a reward provided to the buyer (for example, a discount on goods) corresponds to the real characteristics of the buyer. It may be much more important for a seller to involve a potential client in communication, for example, in order of promoting himself, and he is ready to give a potential buyer any reward from certain limits only due to the fact that the buyer will take a test on the seller's website. In this case, the size of the discount, data on the buyer's individual characteristics and fair assessment thereof does not matter for the seller.

However, in the most preferable embodiment, the system calculates a monetary equivalent taking into account the identified individual characteristics of the buyer. In this case, the seller sets specific requirements for the buyer's individual characteristics and calculates a monetary equivalent (or, in other words, the non-monetary part of the buyer's offer) according to the degree of compliance of the buyer's characteristics with the requirements imposed thereon. Thus, the more the buyer's individual characteristics meet the seller's requirements, the greater the non-monetary part of the offer the buyer can “earn” during testing, and, as a result, the easier it will be for the buyer to cover the missing difference between the price of the goods proposed by the buyer and the selling price of the goods.

In accordance with the embodiment of the invention disclosed in the previous paragraph, the method further comprises the steps of: saving the requirements for the buyer's individual characteristics to be identified during testing to the system; identifying the buyer's individual characteristics from the obtained test results; calculating for each identified individual characteristic of the buyer the degree of its compliance with the specified requirements; the system performs the step of converting the obtained test results into a monetary equivalent taking into account the said calculated degrees; for testing the buyer, the system selects a scenario aimed at identifying the buyer's specific individual characteristics. The requirements for the buyer's individual characteristics can be expressed, for example, in the form of a list of features that the seller would like to see in his clients. Since such requirements affect the size of the non-monetary part of the buyer's offer and, as a result, the price at which the buyer actually purchases the goods, they must be saved to the system as hidden data.

The list of requirements for the buyer's individual characteristics in the standard case is compiled directly by the seller and, as a rule, is associated with the seller's profile, mission and/or value system. Let us assume that the seller is a company selling sporting goods and promoting a healthy lifestyle. Such company is ready to support and stimulate clients who share its values. It is logical to assume that in order to test the buyer in accordance with the method proposed in the present invention, this commercial entity will select a scenario that allows identifying the buyer's attitude to sports and a healthy lifestyle. Accordingly, the list of requirements of this commercial entity for the buyer's individual characteristics will also relate to sports and a healthy lifestyle.

In an alternative embodiment of the invention, the requirements for the buyer's individual characteristics can be generated without the seller's knowledge and without reference to the seller's preferences. For example, these requirements can be compiled by a specialized computer system independent of the seller that implements common standardized algorithm for communicating with the user.

According to one embodiment of the invention, hidden data, used in the proposed method, with the requirements for the buyer's individual characteristics can be generated in a manner that an appropriate weighting coefficient, selected according to a certain algorithm, for example, accounting for the importance of this individual characteristic for the seller, will be assigned to each individual characteristic to be identified. In this case, the step of converting the obtained test results into a monetary equivalent will be performed by the system based on the analysis of weighting coefficients corresponding to those individual characteristics of the buyer that were identified by the system in the step of testing the buyer.

Let us explain this embodiment of the invention by returning to the example with a company selling sporting goods discussed earlier. Let us assume that the said company sets the following hidden requirements for a potential buyer (for simplicity, let us be limited with two): he should not smoke and be able to do more than 5 pull-ups on a horizontal bar. In case of simultaneous compliance with both of these requirements, the seller is ready to provide the buyer with the maximum possible monetary bonus of 100 rubles. Let us also assume that both of these requirements are of equal importance for the seller, and the corresponding characteristics of the buyer are identified as a result of testing with 100% confidence. Then, as weighting coefficients for the specified requirements, the system can set, for example, the following:
does not smoke at all=1;
smokes less than 8 cigarettes a day=0.4;
smokes at least 8 cigarettes a day=0;
can do more than 5 pull-ups=1;
less than 5, but not less than 1=0.4;
can't at all=0.

Thus, if the buyer's answers show that he smokes four cigarettes a day and can do six pull-ups maximum, the non-normalized coefficient for calculating the non-monetary part of his offer will be 0.4+1=1.4, and the normalized coefficient, i.e. brought to the maximum possible result, will be (0.4+1)/2=0.7. As a result, the amount of the bonus provided by the seller will be calculated as 100×0.7=70 rubles.

In another example, let us assume that a certain company makes the following exhaustive set of requirements for a potential buyer: kindness, honesty, politeness. Let us also assume that honesty is ranked by the seller as the most important quality, having importance degree of 0.5. Kindness comes second with a degree of 0.3 and politeness comes third, having importance degree of 0.2. It is worth noting that in this case, the indicated importance degrees act as weighting coefficients to be accounted for when calculating a monetary equivalent. Finally, let us assume that during the testing of the buyer, the system identified in the buyer the following degrees of expression of the said three features: kindness=0.8; honesty=0.7; politeness=0.5. In this case, the coefficient for calculating the non-monetary part of the buyer's offer can be calculated, for example, as the sum of the products of the degrees of expression and importance. In this case, it will be: 0.5×0.7+0.3×0.8+0.2×0.5=0.35+0.24+0.1=0.69.

In order to provide additional information about the invention, it is worth noting that when calculating the said weighting coefficients assigned to each identified feature of the client, in addition to the degrees of expression and importance, the system can take into account other relevant indicators, for example, the probability of correct determining the identified feature from the answers provided by the user, the volume of user answers, the volume of relevant user answers in the total number of answers, etc.

Step g) ends with summation of the calculated monetary equivalent with the price proposed by the buyer. Thus, the system supplements the monetary part of the buyer's purchase offer, expressed by the specific price that the buyer is ready to pay for the goods, with the non-monetary part of the buyer's offer, which is the converted test results (FIG. 16b). In other words, in step g), the system calculates the buyer's total purchase offer.

If, for example, the initial purchase price of the goods proposed by the buyer was 500 rubles, and during testing the buyer “earned” additional 70 rubles of the non-monetary part of the offer, then the buyer's total purchase offer amounted to 570 rubles.

In step h), the system compares the amount calculated in step g), consisting of the monetary equivalent and the price proposed by the buyer, with the minimum acceptable price of the goods. In other words, the system compares the buyer's total purchase offer with the minimum acceptable price.

And in the final step i), the system implements a transaction for the sale of goods at the price proposed by the buyer (FIG. 16b), if the amount calculated in step h) is not less than the minimum acceptable price of the goods. An expected consequence of step i) is that the system does not implement a transaction for the sale of goods at the price proposed by the buyer if the amount calculated in step h) is less than the minimum acceptable price of the goods.

The method for conducting online retailing proposed in the invention, corresponding to its general embodiment was disclosed above. More specific, particular embodiments of this method will be disclosed further.

According to the preferred embodiment of the invention, the claimed method for conducting online retailing further comprises a step, wherein the system invites the buyer to retest for individual characteristics and/or raise the proposed price if the buyer's total purchase offer is less than the minimum acceptable price of the goods. This embodiment of the invention provides for the possibility of further negotiations between the seller and the buyer, if on the results of the first virtual round of negotiations, the parties did not come to a compromise.

Let us assume that the minimum acceptable price of the goods, set by the seller in the form of hidden data, was 800 rubles. The buyer proposed a price of 600 rubles as the initial price. In addition, according to the results of testing, the buyer's individual characteristics were estimated by the system as additional 150 rubles. In this case, the buyer's total purchase offer, 750 rubles, will still be less than the price for which the seller is ready to sell the goods. In this case, the method, according to the preferred embodiment of the invention, offers the buyer four possible options: 1) refuse to purchase the goods and stop interacting with the seller; 2) raise the price proposed for the goods, i.e. increase the monetary part of the purchase offer; 3) take a retest in order to improve test results and thereby increase the non-monetary part of the offer; and 4) perform options 2) and 3) simultaneously.

Depending on the seller's desire, the claimed method can provide the buyer with both a limited and unlimited number of retest attempts. In this case, according to the preferred embodiment of the invention, the test scenario selected for each new retry may differ from the previous one by increased complexity and/or volume and/or duration of implementation. As a result, the buyer will have to make more and more efforts to cover the missing difference between the price proposed by the buyer and the price that satisfies the seller.

If the buyer refuses to continue testing or raise the price proposed earlier, the system will send him a notification on the impossibility of making a transaction at the price proposed by the buyer, and the method will end there without registration of the sale.

According to one possible embodiment of the method, the system can directly inform the buyer that the buyer managed to earn a reward during testing, as well as display the amount of this reward on the screen of the user device. For example, the system can forward an informational message to the user such as “According to the test results, You have been given a discount of 555 rubles”. However, in the standard case, the reward calculated in step g) is kept secret from the buyer, and only the final result of the transaction is reported to the buyer: whether the seller accepts the buyer's total purchase offer or not. This embodiment of the invention protects the seller from possible accusations from the buyer of his alleged discrimination, when the buyer, dissatisfied with the discount provided, tends to consider the situation not as an objective assessment of his individual characteristics, but as his oppression on racial, religious, status or any other grounds.

The method for conducting online retailing described above is implemented via a networked computer system. By its technical implementation, such a computer system may not differ in any way from other similar systems, for example, from the system of an ordinary online store. Therefore, this system is not disclosed in great detail in this application. It is worth noting that in the standard case, such a computer system is a hardware-software complex implemented on the basis of a processor server and equipped with a memory tool, an information input-output tool, and a mean of communication with the network and network devices. Each of the mentioned components of the system can be made as a single block, or as a group of blocks that perform their function in combination with each other. Therefore, in accordance with the invention, the terms “a block” and “a group of blocks” or “a mean” and “means” are equivalent. For example, the said memory tool can be represented by three different storage devices, the first of which stores open data on the product, the second stores hidden data on the product, and the third stores test scenarios. Finally, it is worth noting that in the alternative embodiment, the computer system may be cloud-based and be implemented, for example, on the basis of virtual machines.

Regardless of the variant of technical solution, the computer system claimed in the invention is configured to perform steps a)-i) described above. For completeness of disclosure, it is worth noting that discussed are the steps of: saving open data on the product, containing at least the name and regular price of the product to the memory tool; saving hidden data on the product, containing its minimum acceptable price being equal to or less than the regular price of the product to the memory tool; saving at least one hidden scenario of testing a buyer to identify his individual characteristics to the memory tool; publishing online an offer to sell a product with indication of open data on this product; receiving an offer from the buyer to purchase goods at a price proposed by the buyer; selecting a scenario of testing the buyer for his individual characteristics from the scenarios available in the memory tool; sending an offer to the buyer to take a test to identify his individual characteristics according to the selected test scenario; if the buyer accepts, the buyer is tested and test results that correspond to the buyer's individual characteristics are obtained; converting the obtained test results into a monetary equivalent and summing this monetary equivalent with the price proposed by the buyer, comparing the calculated amount with the minimum acceptable price of the goods; implementing a transaction for the sale of goods at the price proposed by the buyer, if the sum calculated is not less than the minimum acceptable price of the goods.

Other features and characteristics of the claimed system substantially correspond to the similar features and characteristics mentioned above when describing a method for conducting online retailing.

The second aspect of the invention relates to a method for providing a reward by a commercial entity to a client taking into account his individual characteristics. In general, this method is an independent, functionally complete method that is not directly related to trading or obtaining personal information of counterparties. For example, this method can be used to promote a commercial entity among potential clients. Let us assume that a new manufacturer enters the juice market and wants to attract clients. Instead of, or in addition to, standard direct advertising, this manufacturer can take advantage of the present invention by running a campaign to distribute rewards in exchange for clients demonstrating their individual characteristics. Accordingly, potential juice consumers are involved in the testing process on the manufacturer's website, undergo this testing, interacting with the manufacturer through the dialogue, and in return receive a reward, for example, a box of the same juice. As a result, potential juice consumers discover a new manufacturer, remember it, distinguishing it from a variety of similar producers, and subconsciously feel trust and gratitude towards this manufacturer, considering its actions disinterested. As for a commercial entity, in exchange for the small costs associated with providing a reward, it becomes famous in the market and gets new clients, with an ideal combination of circumstances—loyal clients.

Another possible objective of the method according to the second aspect of the invention is to obtain personal information about clients of a commercial entity. The possibility of obtaining such information is absolutely obvious: by testing a client for his individual characteristics, a commercial entity automatically receives data that makes it possible in one way or another to form an idea of the personality of the client being tested. Obviously, the collection of personal information should not violate the law on personal data protection, but this can be easily avoided by selecting an appropriate client test scenario. In this regard, it is worth noting that a commercial entity, as a rule, does not need to know unauthorized information about its clients. All it needs, from a commercial point of view, is to make a so-called target client profile in order to conduct a more competent marketing policy in the market, with this information accounted for. Obviously, the present invention can provide such tools to a commercial entity without violating the current law on personal data protection.

Nonetheless, in the most practically applicable embodiment, the method according to the second aspect of the invention should be used as part of the method for conducting online retailing disclosed earlier. In this case, the seller of the goods acts as a commercial entity, the buyer of the goods acts as a client, and the discount for the goods provided to the buyer is considered as a reward. Thus, it should be apparent that the claimed method for providing a reward by a commercial entity to a client, in a number of its steps, almost completely coincides with the method for conducting online retailing disclosed earlier. More specifically, the method for providing a reward to a client is characterized by comprising at least the steps of (for convenience, these steps are designated by letters j-n, which should not be considered as limiting the scope of the invention claims):
j) saving at least one hidden scenario of testing a client to identify his individual characteristics to the system;
k) the system sends an offer to the client to take a test to identify his individual characteristics according to the selected test scenario in exchange for a possible reward;
I) if the client accepts, the client is tested and test results that correspond to the client's individual characteristics are obtained by the system;
m) the system converts the obtained test results into a reward;
n) providing the client with a reward.

Having compared this method with the one disclosed earlier, it can be seen that its steps j), k), 1), m) correspond to a greater or lesser extent to steps c), e), f), g) of the method for conducting online retailing. As for the differences, it should be noted that step k) of the method according to the second aspect of the invention is formulated more specifically than step e) of the first method. In fact, if in some embodiments of the first method the test results are not important for the seller, since testing can be carried out simply as part of a campaign to promote the seller among potential clients, then in the second method, testing is carried out, inter alia, in order to identify the client's individual characteristics. In addition, a reward, according to this aspect of the invention, is provided in return to the identified characteristics of the client.

Another difference between this method and the one disclosed earlier is that at its step m) a reward is not summed with the price proposed by the buyer. This difference is quite obvious, since this method does not comprise the steps directly related to conducting retailing. However, instead of steps related to conducting retailing, the method according to the second aspect of the invention comprises step n), in which a client is provided with a reward. Earlier, by the example of a juice box, it was mentioned that the reward provided to the client can have a tangible embodiment. Equally, this reward may be non-monetary (for example, provision of a service) or monetary.

According to one embodiment of the second method, a reward is provided to a client directly by a commercial entity. However, there may be a case when a reward, with the consent of the commercial entity, is provided by the other party. In a typical case, such a reward can be provided by the computer system itself involved in the implementation of the proposed method. For example, this system can provide a reward in the form of a discount on the product being sold.

The method according to the second aspect of the invention in great part coincides with the method according to the first aspect of the invention. For this reason, there is no need to describe in detail those embodiments of the second method that fully or partially correspond to similar embodiments of the first method disclosed earlier. Those skilled in the art should understand how the embodiments of the first method can be converted into the corresponding embodiments of the second method, taking into account the differences between these two methods, mainly related to conducting retailing.

In addition, the second aspect of the invention relates to a computer system for calculating a reward to a client, taking into account his individual characteristics. Such a system can be used for the practical implementation of the corresponding method, also related to the second aspect of the invention. However, unlike this method, this system, in its basic embodiment, is not capable of providing a reward to a client. Its action ends with the calculation of the amount of a reward and, as a result, the proposed system cannot perform the last step of the corresponding method, i.e. the step of providing a reward to a client. It is assumed that a commercial entity performs this last step by itself. Also, in some embodiments of the invention, it is possible that a commercial entity will delegate its authority to reward a client to a certain third party, including the same computer system that calculated this reward, and already a third party, not a commercial entity, will provide a reward to the client. However, due to the fact that a reward, in the standard case, is associated with the burden of incurring material costs, this action to provide a reward is beyond the scope of the claimed computer system. It is for this reason that the computer system according to the second aspect of the invention is not capable of providing a reward to a client. According to the present invention, this action is performed by a commercial entity, perhaps not directly, but undoubtedly with their knowledge.

By analogy with the aforesaid with respect to the claimed methods, the principles of technical implementation of the computer system according to the second aspect of the invention exactly correspond to the system for conducting online retailing disclosed earlier. Therefore, in this application, this system for calculating a reward to a client is not described in detail. It is only worth noting that this computer system is configured to perform at least the following set of actions: selecting a scenario of testing a client for his individual characteristics from the scenarios available in the memory tool; sending an offer to the client to take a test to identify his individual characteristics according to the selected test scenario; if the client accepts, the client is tested and test results that correspond to the client's individual characteristics are obtained; converting the obtained test results into a reward. The listed actions of the system substantially correspond to steps j)-m) of the method for providing a reward to a client described above.

In accordance with its third aspect, the invention relates to a method for identifying the degree of compliance of the client's individual characteristics with the requirements of a commercial entity. In the broadest embodiment, this method is characterized by comprising at least the steps of (for convenience, these steps are designated by letters o-s, which should not be considered as limiting the scope of the invention claims):
o) saving hidden data with the requirements for the client's individual characteristics and at least one scenario of testing the client to identify his individual characteristics to the system;
p) the system sends an offer to the client to take a test to identify his individual characteristics according to the selected test scenario;
q) if the client accepts, the client is tested and test results that correspond to the client's individual characteristics are obtained by the system;
r) the system calculates the degree of compliance of the client's individual characteristics, identified during testing, with the specified requirements from hidden data;
s) saving the calculated degree of compliance to the database.

In direct analogy with the first two methods, this third method can also be used only to implement its direct purpose, indicated in its name. For example, a commercial entity may be interested in obtaining information about the degree of compliance of its clients with certain requirements, in order to get an idea of the features of its current clientele. In another case, by identifying the degree of compliance of the individual characteristics of the counterparty with the requirements of a commercial entity, the commercial entity can observe the dynamics of changes in its clientele as changes are made to its business activities. For example, a trading company can assess how its average client is changing as this company is rebranded.

However, in the most preferable, from a practical point of view, embodiment, this third method is a functionally complete part of the first two methods. In this regard, it is worth noting that the advantage of separating the third method into a separate method that is not directly related to the first two, is that in this case, the compliance of the client's individual characteristics with the requirements of a commercial entity can be identified regardless of the time and conditions of implementation of the said first two methods. In addition, the method according to the third aspect of the invention may be performed by a third party that is not related to commercial entities implementing online retailing or providing a reward to a client. In this case, the client's test results will be provided by a third party to a commercial entity in a ready-made form.

Let us explain the aforesaid by a simple example. For example, a certain cultural fund, on the occasion of the anniversary of Alexander Pushkin, wants to encourage people being well familiar with Pushkin's work with symbolic gifts. For some reason, for example, due to the lack of technical capabilities, this fund is unable or unwilling to independently test people to assess their knowledge. In other words, the fund cannot independently implement a method according to the second aspect of the invention. However, in this case, the fund can use the advantages provided to it by the third aspect of the invention. Accordingly, the fund may apply for testing to a third party and obtain the test results it needs from that third party. Obviously, for the purposes of such testing, the said third party must have a computer system capable of performing the method according to the third aspect of the present invention, and the requirements for the individual characteristics of the client will include requirements for knowledge of Pushkin's work. It should also be understood that testing clients for Pushkin's work knowledge can be performed by the third party even before the cultural fund applies to this third party, i.e. in advance. In this case, the relevant test results can be saved to the database of the third party for an indefinite period of time, and subsequently they can be immediately provided to the interested party upon their request.

Thus, according to the third aspect of the invention, the collection of information about the client's individual characteristics can be performed regardless of the activities of those organizations that will subsequently use this information for their own purposes. In addition, the collection of this information can be performed, as they say, “as a reserve”, i.e. even before a certain organization applies for it. It is apparent that these features of the present invention increase its versatility and flexibility, and therefore, are further advantages of the invention.

Having compared the third method (the method for identifying the degree of compliance) with the method according to the second aspect of the invention (the method for providing a reward), it can be seen that steps o), p), q) of the third method correspond to a greater or lesser extent to steps j), k), I) of the method for providing a reward.

As for the differences between these two methods, step o) of the method according to the third aspect of the invention further includes a sub-step, in which hidden data with the requirements for the client's individual characteristics is saved to the system. Let us explain that according to the possible embodiments of the method according to the second aspect of the invention, a reward can be provided to a client regardless of his individual characteristics. As a result, in the method according to the second aspect of the invention, the system may not save hidden data with the requirements for the client's individual characteristics and does not need the corresponding sub-step of the third method. However, in the method according to the third aspect of the invention, the sub-step of saving data with the requirements for the client's individual characteristics is mandatory, since otherwise it is impossible to implement the method according to its intended purpose.

Another difference between the third method and the second one disclosed earlier is that it does not calculate a reward, but the degree of compliance of the client's individual characteristics, identified during testing, with the requirements of a commercial entity. This degree of compliance is saved to the database of the system and can be subsequently read from this database and transmitted to the interested party.

Similarly, the third method discussed can be considered as part of the method for conducing online retailing according to the first aspect of the invention. In this case, this method for conducting online retailing will be implemented without steps c), e) and f), which will become needless in light of the method according to the third aspect of the invention included in it. In this case, step g) of the first method will be modified in terms of calculating a monetary equivalent. The reason for this modification is that the method according to the first aspect of the invention receives, in the form of input data, the degree of compliance of the client's individual characteristics with the requirements of a commercial entity, calculated during the implementation of the method according to the third aspect of the invention. Accordingly, in the method for conducing online retailing in step g), not the test results will be converted into a monetary equivalent, but the mentioned degree of compliance, which was calculated by implementing the method according to the third aspect of the invention and which enters the method according to the first aspect in a ready-made form.

Since the method according to the third aspect of the invention in great part coincides with the first two, there is no need to describe in detail those embodiments of the third method that fully or partially correspond to similar embodiments of the first and second methods disclosed earlier. Those skilled in the art should understand how the embodiments of the first and/or the second method can be converted into the corresponding embodiments of the third method, taking into account the differences between these three methods, related mainly to conducting retailing, providing a reward and calculating the degree of compliance of the client's individual characteristics with the requirements of a commercial entity.

In addition, the third aspect of the invention relates to a computer system for identifying the degree of compliance of client's individual characteristics with the requirements of a commercial entity. By analogy with the aforesaid with respect to the claimed methods, the principles of the technical implementation of such a computer system exactly correspond to the systems for conducting online retailing and calculating a reward for a client disclosed earlier. Therefore, in this application, this system for identifying the degree of compliance of client's individual characteristics with the requirements of a commercial entity is not described in detail. It is only worth noting that this computer system is configured to perform steps o)-s) described above.

Further, with reference to a particular embodiment, the implementation of the proposed invention in practice will be disclosed. For the purpose of illustration, let us choose an example related to the first aspect of the invention, namely, the method for conducting online retailing. This choice is made due to the fact that the said method for conducting online retailing is the most preferable from a practical point of view. In addition, it includes, in the form of constituent parts, the other two aspects of the invention. Therefore, the disclosure of the embodiment according to the first aspect of the invention (the method of conducting online retailing) will automatically include the disclosure of the other two aspects, i.e. the method for providing by a commercial entity a reward to a client, taking into account the client's individual characteristics, and the method for identifying the degree of compliance of client's individual characteristics with the requirements of a commercial entity.

Let us assume that there is a certain company, “Vertical”, selling hiking outfit, which sells it including through the Internet. For these purposes, the “Vertical” company has a networked computer system equipped with at least a processor device, a memory tool and means of communication of the processor device with the memory tool and with the network. The “Vertical” company places on its web page an offer for the sale of backpacks of the “Everest” brand at the regular price of 4000 rubles. This offer for sale is public, so any Internet user can visit the page with this offer and get information about characteristics and price of the backpack presented.

The economists of the “Vertical” company calculated that the price of the “Everest” backpack can be reduced to the amount of 3,300 rubles. Such a price change will be acceptable for the company, however, the sale of the backpack at a price below 3300 rubles may no longer be economically viable. Accordingly, the “Vertical” company saves to its system an indication that the minimum acceptable price of the “Everest” backpack is 3,300 rubles. According to the principles of the present invention, this minimum price is saved to the computer system memory in the form of hidden data, therefore potential buyers of the goods and third parties cannot find out this price, at least by legal means. It is also worth noting that the characteristic “minimum acceptable price of a product” can be easily converted into the characteristic “maximum possible discount for a product”, which is inversely related to the first and represents the difference between the regular price of a product and its minimum acceptable price.

Due to personal reasons, not related to business, the “Vertical” company management feels sympathy for people having such qualities as a sense of partnership, moderation, fortitude and courage. In an effort to encourage people having these qualities at least to some extent, the “Vertical” company management agrees to sell their goods to these people at a discount. And if a potential buyer possesses the mentioned set of qualities to their maximum extent, the company agrees to sell their goods to this buyer at the minimum acceptable price. For the “Everest” backpack, it will be 3300 rubles. If to consider the issue in terms of discounts rather than prices, then if a potential buyer demonstrates maximum compliance with the seller's requirements, he will be able to earn the maximum possible discount. For the “Everest” backpack, this maximum discount will be 700 rubles.

In order to test clients for their individual characteristics, the “Vertical” company saves to its system hidden test scenarios, that allow identifying in the tested user the extent to which he has a sense of partnership, moderation, fortitude and courage. Let us assume that the “Vertical” company values a sense of partnership above all. The company gives it a weighting coefficient of 0.4 and assigns a separate test scenario for it. The remaining qualities are to be identified within one general test scenario and are ranked by the seller according to their importance as follows: moderation=0.2; fortitude=0.3; and courage=0.1. For clarity, the seller's individual characteristics, being of interest to the seller, and their corresponding importance degrees (or, in other words, weighting coefficients) are summarized in Table 1. It can be seen that used in this example are already normalized weighting coefficients, the total amount of which is equal to one (0.4+0.2+0.3+0.1=1).

TABLE 1

| Individual characteristic | |
|---|---|
| being identified | Importance |
| Sense of partnership | 0.4 |
| Moderation | 0.2 |
| Fortitude | 0.3 |
| Courage | 0.1 |

The required test scenario, for the “Vertical” company, can be developed on the basis of a neural network, with the involvement of psychologists, sociologists, graphologists, linguists and other professionals. For example, it can be implemented in such a manner that by duplicating, inverting, reinterpreting and clarifying questions, it can recognize honest and dishonest answers from users, filter out all non-essential and select the most informative content related directly to the subject matter of testing.

Let us further assume that a person, for example Mr. Ivanov, trying to buy a new backpack via the Internet using a smartphone, came across a corresponding offer from the “Vertical” company. The price, design and functionality of the “Everest” backpack, published on the company's website, completely suit Mr. Ivanov, and he is willing to purchase such a product. An extra motivation to make a purchase is provided by an informational advertisement, displayed on the “Vertical” company's website, which informs that the buyer can try to bargain with the seller and purchase the goods at a lower price. To do this, the buyer must, firstly, register on the seller's website, specifying the details of his bank card; secondly, select a product and offer his counter price for it, i.e. form a monetary part of the purchase offer, and, thirdly, undergo testing to demonstrate his individual characteristics. Based on the results of such testing, the monetary part of the buyer's offer will be supplemented with a non-monetary part, and then the system will decide whether or not to sell the backpack to Mr. Ivanov at the price proposed by him.

Mr. Ivanov agrees to bargain, enters, using a smartphone, his bank card details into a special form on the “Vertical” company's website, selects a backpack he likes and sends a message to the seller (for example, also using a special form) that he is ready to purchase the “Everest” backpack for 3000 rubles. Since the amount of 3000 rubles, proposed by Mr. Ivanov, is less than the regular price of the product (4000 rubles), the system in response sends him an offer to take a test. Alternatively, the system can immediately start testing, since the fact that Mr. Ivanov agrees to participate in trading can be automatically considered by the system as his consent to undergo testing. For example, let us assume that, taking into account the difference of 1000 rubles between the regular and proposed prices of the product, the system selects test scenarios of average complexity and duration of implementation. It is worth to remind that according to the exemplary embodiment under consideration, the system will test the buyer for the presence of a sense of partnership within one scenario and for the presence of “moderation”, “fortitude” and “courage” within another scenario, common to all these three qualities. The test scenarios selected by the system can be displayed on Mr. Ivanov's smartphone in any order and have any embodiment.

Let us assume that according to the test results, the system identified that the buyer Ivanov has a sense of partnership to the extent of 0.3 (from the maximum possible value), moderation—0.7, fortitude—0.2 and courage—0.5 (these results are presented below in Table 2).

TABLE 2

| Individual characteristic | | |
|---|---|---|
| being identified | Importance | Expression |
| Sense of partnership | 0.4 | 0.3 |
| Moderation | 0.2 | 0.7 |
| Fortitude | 0.3 | 0.2 |
| Courage | 0.1 | 0.5 |

According to this example, when converting test results into a monetary equivalent, the system uses an estimated coefficient calculated as the sum of the products of the degrees of expression and importance, while the system calculates the monetary equivalent as the product of the estimated coefficient and the maximum possible discount. In this case, the estimated coefficient will be 0.4×0.3+0.2×0.7+0.3×0.2+0.1×0.5=0.12+0.14+0.06+0.05=0.37. As a result, the amount of the monetary equivalent (or, what is the same, the amount of the non-monetary part of the offer or the bonus provided to Mr. Ivanov) will be equal to the product of 0.37×700=259 rubles.

Thus, during testing, Mr. Ivanov earned additional 259 rubles, which makes the non-monetary part of his purchase offer. Together with the monetary part of the offer, i.e. the price proposed by Mr. Ivanov initially, this non-monetary part of the offer will make the total purchase offer. In this example, the total offer will make 3000+259=3259 rubles. However, since the amount of 3259 rubles is less than the minimum acceptable price of the product (3300 rubles), the system will refuse the buyer in the transaction and offer him to increase the monetary and/or non-monetary part of the offer. Obviously, in order to increase the monetary part of the offer, Mr. Ivanov will need to increase his price offer, i.e. the amount that he will need to pay for the product with real money. In order to increase the non-monetary part of the offer, the buyer will need to be retested and during this re-testing show the best compliance with the seller's requirements.

For comparison, in an ideal situation for Mr. Ivanov, wherein he would be able to demonstrate the maximum degree of compliance of his characteristics with the seller's requirements, the amount of the bonus earned by Mr. Ivanov would be calculated as follows: 700×(0.4×1+0.2×1+0 0.3×1+0.1×1)=700×(0.4+0.2+0.3+0.1)=700 rubles. In this idealized case, Mr. Ivanov would be able to buy the “Everest” backpack, spending only 2,600 rubles, from his real money (i.e. even cheaper than the minimum acceptable price of the product), since the maximum bonus of 700 rubles would cover the missing difference between the minimum acceptable price of the product (3,300 rubles) and the minimum possible amount of the monetary part of the offer (2,600 rubles). However, in practice, this ideal situation is hardly likely. Firstly, the 100% compliance of the buyer with the seller's requirements is a big accident. Secondly, the user does not know what qualities he is being tested for, and therefore his ability to guess the correct answers is reduced to zero. Thirdly, in practice, testing, as a rule, is carried out to identify a much greater number of individual characteristics than four. Therefore, the probability of presenting a large number of ideal answers is significantly reduced.

Having received a notification from the system on the refusal in the transaction on the initial terms, the buyer decides to continue interaction with the system. To do this, he sends the seller a new offer to buy the “Everest” backpack, increasing the monetary part of the purchase offer to 3200 rubles. In response the system invites Mr. Ivanov to retest and selects new scenarios for retesting. By way of example, let us assume that in order to test the client for “a sense of partnership”, the system selects a test scenario that differs from the previous one by increased complexity and duration of implementation. With respect to the qualities of “moderation”, “fortitude” and “courage”, the system selects a new scenario that coincides with the previously used one in terms of complexity and duration of implementation.

Let us assume that during the retesting, Mr. Ivanov slightly updated his previous results. According to the updated data, he managed to demonstrate higher degrees for a sense of partnership (0.4) and fortitude (0.2), while the degree of courage remained unchanged (0.5), and the degree of moderation decreased to 0.3. The results of the new testing, along with the previous ones, are presented below in Table 3.

TABLE 3

| Individual characteristic | Impor- | Previous degree | New degree |
|---|---|---|---|
| being identified | tance | of expression | of expression |
| Sense of partnership | 0.4 | 0.3 | 0.4 |
| Moderation | 0.2 | 0.7 | 0.6 |
| Fortitude | 0.3 | 0.2 | 0.3 |
| Courage | 0.1 | 0.5 | 0.5 |

Thus, using the previously selected algorithm for calculating a monetary equivalent, the system determined that during retesting Mr. Ivanov earned a bonus of 294 rubles. The calculation details are as follows: 700×(0.4×0.4+0.2×0.6+0.3×0.3+0.1×0.5)=700×(0.16+0.12+0.09+0.05)=700×0.42=294 rubles. Together with the increased monetary part of the offer, this new non-monetary part of the offer will make a total offer of 3200+294=3494 rubles.

Since the amount of 3,494 rubles exceeds the minimum acceptable price of the product (3,300 rubles), the system accepts the buyer's offer. Accordingly, the system sends a message to Mr. Ivanov informing that the transaction has been implemented, writes off the amount of 3,200 rubles from his card, marks in the database that the “Everest” backpack is reserved for delivery to the buyer, and sends an order to a warehouse to ship the product.

During the described interaction between the buyer and the seller, the buyer managed to purchase the product with a significant discount (3,200 rubles versus 4,000 rubles), which cannot but be perceived by him as luck. In addition, the buyer may be pleased to realize that the discount was given to him in return to the demonstration of certain qualities, i.e. that the buyer's individual characteristics are highly appreciated. All this undoubtedly improves the mood of the buyer, he feels that buying goods via the Internet can have a human aspect, and he is ready to continue participating in such schemes.

As for the seller, in addition to the fact that the seller sold the goods on acceptable terms and experienced satisfaction from the encouragement of a person, being close to the seller by personal qualities, the seller highly likely got a regular client. The probability of such an event is rather high, since the method for conducting retailing implemented by the seller, in accordance with the principles of the present invention, has the most advantageous effect on the establishment of trusting friendly relations with potential clients.

If the company under no circumstances agrees to sell their goods at a price below the cost of the goods, then it should choose the regular price of the goods as the minimum acceptable price, and the difference between the regular price of the goods and its cost as the maximum possible value of the non-monetary part of the offer. In this case, the system, even theoretically, will not be able to sell a product below its cost. If the buyer, as the monetary part of the offer, proposes a price less than the cost of the goods, then even with the most successful test result, the non-monetary part of the offer earned by the buyer will not be enough for the system to approve the transaction.

Let us explain the aforesaid by the example discussed earlier. For example, the cost of the “Everest” backpack is 3000 rubles, and Mr. Ivanov's initial purchase offer for this backpack is 2900 rubles, i.e. less than the cost. Let us further assume that when implementing the method under consideration, the system selects the regular price of the “Everest” backpack, of 4000 rubles, as the minimum acceptable price of this product. In this case, the system determines the maximum possible value of the non-monetary part of the offer as 1000 rubles (the difference between the regular price and the cost).

Let us further assume that during testing Mr. Ivanov managed to demonstrate the maximum degree of compliance of his characteristics with the seller's requirements, i.e. the coefficient for calculating the non-monetary equivalent turned out to be equal to one, which corresponds to its maximum possible value: 0.4×1+0.2×1+0.3×1+0.1×1=1. As a result, Mr. Ivanov managed to earn the maximum possible bonus of 1000 rubles, i.e. 100% of the set maximum value of the non-monetary part of the offer.

However, even in such an ideal case, the amount of the buyer's total offer will be less than the minimum acceptable price of the product, 3900 rubles. (2900+1000) against 4000 rubles. Accordingly, the system will refuse the buyer in the transaction and offer him to increase the monetary and/or non-monetary parts of the offer. In this case, it is apparent that Mr. Ivanov can only increase the monetary part of the purchase offer, since the non-monetary part has already reached its maximum value. However, according to the standard embodiment of the method, this information is not available to Mr. Ivanov, and he may try to undergo testing again and again in an unpromising attempt to increase the non-monetary part of the offer. At some point in time, the buyer will give up and either refuse the transaction, or increase the monetary part of the offer to an acceptable level. Nonetheless, according to this embodiment of the invention, the system, regardless of Mr. Ivanov's behavior, will not sell him the product till the monetary part of his offer exceeds the cost of the product.

1. A method for conducting online retailing via a networked computer system, comprising the steps of:
placement by the seller of an offer to sell a product with indication of open data on this product, containing at least its name and regular price;
saving, by the seller, hidden data on the product, including its minimum acceptable price, which is equal to or less than the regular price of the product to the system;
saving, by the seller, hidden data on his requirements for the buyer's individual characteristics to the system;
saving at least one hidden scenario of testing the buyer to identify his individual characteristics to the system;
selecting a product by the buyer and sending an offer to the seller to purchase the product at the price proposed by the buyer;
the system select scenarios of testing the buyer;
the system sends an offer to the buyer to take a test according to the selected test scenario;
if the buyer accepts, the buyer is tested and test results are obtained by the system, identifying the degree of compliance of the buyer's individual characteristics with the seller's hidden requirements;
the system converts the obtained test results into a monetary equivalent and sums this monetary equivalent with the price proposed by the buyer;
the system compares the amount calculated in the previous step with the minimum acceptable price of the product;
the system implements a transaction for the sale of the product at the price proposed by the buyer, if the calculated amount is not less than the minimum acceptable price of the product.

2. The method according to claim 1, wherein the system performs the step of converting the obtained test results into a monetary equivalent by assigning an appropriate weighting coefficient to each test result, followed by summing these coefficients.

3. The method according to claim 2, wherein the weighting coefficient assigned to each test result is randomly selected by the system.

4. The method according to claim 1, further comprising the steps of:
saving hidden data with the requirements for the buyer's individual characteristics to be identified during testing to the system;
the system identifies the buyer's individual characteristics from the obtained test results;
calculating for each individual characteristic of the buyer, identified during testing, the degree of its compliance with the specified requirements from hidden data;
the system performs the said step of converting the obtained test results into a monetary equivalent taking into account the specified calculated degrees characterizing the compliance of the identified characteristics of the buyer with the requirements from hidden data;
for testing the buyer, a scenario is selected aimed at identifying specific individual characteristics of the buyer prescribed in the specified requirements from hidden data.

5. The method according to claim 1, wherein in the said step of saving at least one hidden test scenario, more than one scenario of testing the buyer is saved.

6. The method according to claim 5, wherein the test scenarios used differ from each other by at least one of the following parameters: complexity, volume, duration of implementation, focus on identifying specific individual characteristics.

7. The method according to claim 4, wherein the steps of saving hidden data with the requirements for the buyer's individual characteristics and saving at least one scenario of testing the buyer to the system are performed by the seller.

8. The method according to claim 4, wherein the steps of saving hidden data with the requirements for the buyer's individual characteristics and saving at least one scenario of testing the buyer to the system are performed by a third party.

9. The method according to claim 4, wherein the specified requirements for the buyer's individual characteristics include requirements for his emotional state.

10. The method according to claim 1, wherein the said testing is carried out by questioning the buyer during a system-driven dialogue with the buyer.

11. The method according to claim 1, wherein the buyer is tested by entering text data into the system.

12. The method according to claim 5, wherein the system selects a scenario of testing the buyer based on the price proposed by the buyer.

13. The method according to claim 5, wherein the system randomly selects a scenario of testing the buyer.

14. The method according to claim 6, further comprising a step, wherein the system invites the buyer to retest for individual characteristics and/or raise the proposed price if the specified calculated amount is less than the minimum acceptable price of the goods.

15. The method according to claim 14, wherein the system selects a scenario for retesting that differs from the previous one by increased complexity and/or volume and/or duration of implementation.

16. The method according to claim 14, wherein the system refuses to sell the goods to the buyer at the price proposed by the buyer if the buyer refuses to continue testing or raise the proposed price.

17. The method according to claim 1, wherein the Internet is used as a network.

18. The method according to claim 4, wherein hidden data with the requirements for the buyer's individual characteristics is generated in such a manner that an appropriate weighting coefficient is assigned to each individual characteristic, and the weighting coefficient is selected taking into account the importance of this individual characteristic, while the system performs the step of converting the obtained test results into a monetary equivalent taking into account the weighting coefficients corresponding to those individual characteristics of the buyer that were identified by the system in the step of testing the buyer.

19. The method according to claim 1, wherein in the step of sending an offer to the seller to purchase goods, the buyer indicates the details of his bank card, while the system performs the step of implementing a transaction for the sale of the goods by debiting from the buyer's bank card the amount corresponding to the price proposed by the buyer.

20. The method according to claim 1, wherein the seller places online the specified offer for the sale of goods.

21. The method according to claim 1, comprising a further step, wherein the system sends a message to the buyer about providing the buyer with a discount on the purchase of goods in the amount of the specified monetary equivalent.

22. A computer system for conducting online retailing, including:
a memory tool that stores:
open data on a product, containing at least the name and regular price of the product;
hidden data on a product, containing its minimum acceptable price being equal to or less than the regular price of the product;
and at least one hidden scenario of testing a buyer to identify his individual characteristics;
a processor device;
means of communication of the processor device with the memory tool and with the network;
wherein the processor device is configured to perform the following actions:
publishing online an offer to sell a product with indication of open data on this product;
receiving an offer from the buyer to purchase the product at a price proposed by the buyer;
selecting a scenario of testing the buyer for his individual characteristics from the scenarios available in the memory tool;
sending an offer to the buyer to take a test to identify his individual characteristics according to the selected test scenario;
if the buyer accepts, the buyer is tested and test results that correspond to the buyer's individual characteristics are obtained;
converting the obtained test results into a monetary equivalent and summing this monetary equivalent with the price proposed by the buyer;
comparing the calculated amount with the minimum acceptable price of the product;
implementing a transaction for the sale of the product at the price proposed by the buyer, if the calculated amount is not less than the minimum acceptable price of the product.

23-52. (canceled)
